(19) United States
(12) Patent Application Publication
(10) Pub. No.: US 2018/0157735 A1
(43) Pub. Date: Jun. 7, 2018

(54) METHOD AND SYSTEM FOR CLUSTERING ENGINEERING DATA IN A MULTIDISCIPLINARY ENGINEERING SYSTEM

(71) Applicant: Siemens Aktiengesellschaft, Munich (DE)

(72) Inventors: Oswin Noetzelmann, Diamond Bar, CA (US); Andrew Dylla, Anaheim Hills, CA (US); Attila Labas, Rancho Mission Viejo, CA (US); Marine Durel, Long Beach, CA (US); Michael Glass, Bonn (DE)

(21) Appl. No.: 15/577,927

(22) PCT Filed: Jun. 4, 2015
(86) PCT No.: PCT/US2015/034127

§ 371 Date: Nov. 29, 2017

(51) Int. Cl. G06F 17/30

(52) U.S. Cl. CPC G06F 17/30598; G05B 19/058; G06F 17/30327

(57) ABSTRACT

The preferred embodiments described below include methods, systems and computer readable media for clustering engineering data in a multidisciplinary engineering system. Engineering data in a multidisciplinary engineering system is grouped into clusters (601) of data that can be used to represent an engineering purpose in the multidisciplinary engineering system. The engineering data can be grouped for any engineering purpose, such as a group of devices included in a safety area of an automated facility, a group of devices included in an automation system or a group of devices that are assigned to a specific bus controller. Workstations (305) can access, view and modify the clusters (601) of engineering data from engineering discipline specific engineering applications (307).

### BACKGROUND

The present embodiments relate to multidisciplinary engineering systems. A multidisciplinary engineering system is a system that integrates multiple engineering disciplines, such as design engineering, electrical engineering, mechanical engineering, automation engineering, project management and the like, and allows engineers, technicians and managers from various disciplines to work on common or connected data. For example, factory designers work together with mechanical engineers, electrical engineers, automation engineers and managers to plan a new production line for a car door assembly. In a multidisciplinary engineering system, each discipline has its own representation of data. For example, the same device will be represented differently in each discipline, and different data regarding the device is stored depending on the discipline.

Each engineering discipline works separately from a data point of view. Therefore, manual synchronization of the discipline specific data is required, which is very time consuming and error prone. For example, when an automation engineer introduces a new programmable logic controller (PLC) to automate a production line, information about the PLC is manually transported to an electrical engineering application in order for an electrical engineer to specify an appropriate electrical cabinet to house the PLC and to plan wiring to the PLC. If the PLC information is not transported, or the PLC information is distorted during transport, the missing or incorrect information may impact the quality of the work of both the automation and electrical engineers.

### SUMMARY

By way of introduction, the preferred embodiments described below include methods, systems and computer readable media for clustering engineering data in a multidisciplinary engineering system. Engineering data in a multidisciplinary engineering system is grouped into clusters of data that can be used to represent an engineering purpose in the multidisciplinary engineering system. The engineering data can be grouped for any engineering purpose, such as a data for group of devices included in a safety area of an automated facility, data for a group of devices included in an automation system, or data for a group of devices that are assigned to a specific bus controller. Workstations can access, view and modify the clusters of engineering data from engineering discipline specific engineering applications.

In a first aspect, a method is provided for clustering engineering data in a multidisciplinary engineering system. A server stores a cluster of multidisciplinary engineering data representing an engineering context. The cluster includes a unique identifier associated with the cluster and engineering application objects associated with the cluster. Different ones of the engineering objects are represented in different engineering applications for different engineering disciplines with different roles in the multidisciplinary engineering system. A computer accesses the cluster in one of the different engineering applications and modifies one of the plurality of engineering application objects associated with the accessed cluster.

In a second aspect, a multidisciplinary engineering system is provided for clustering engineering data. A server is configured to store a cluster of multidisciplinary engineering data representing a portion of an engineering model in the multidisciplinary engineering system. The cluster includes engineering application data associated with the cluster, the engineering data represented in different engineering applications for different engineering disciplines with different roles in the multidisciplinary engineering system. Workstations in communication with the server over a network are configured to execute one of the different engineering applications to access the cluster and to modify the engineering application data associated with the accessed cluster.

In a third aspect, a method is provided for clustering engineering data in a multidisciplinary engineering system. A server stores clusters of clusters of multidisciplinary engineering data representing different engineering scopes. The clusters include a unique identifiers and engineering application data associated with each of the clusters. The engineering data represents an engineering model across different engineering applications for different engineering disciplines with different roles in the multidisciplinary engineering system. A computer accesses one of the clusters stored on the server in the different engineering applications and modifies engineering data associated with the accessed cluster in the engineering application.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 illustrates an example of a multidisciplinary engineering system.

FIG. 2 illustrates an example of engineered data in a multidisciplinary system.

FIG. 3 illustrates an example implementation of a multidisciplinary system.

FIG. 4 illustrates an embodiment of a system for clustering engineering data in a multidisciplinary engineering system.

FIG. 5 illustrates another embodiment of a system for clustering engineering data in a multidisciplinary engineering system.

FIG. 6 illustrates an example of adding engineering application data to a cluster of engineering application data.

FIG. 7 illustrates an example of clusters organized in a hierarchical structure.

FIG. 8 is a flowchart diagram of an embodiment of a method for clustering engineering data in a multidisciplinary engineering system.

### DETAILED DESCRIPTION OF EXEMPLARY EMBODIMENTS

The following embodiments describe a solution for grouping or congregating engineering data from multiple engineering dimensions to utilize the clustered data in domain specific engineering tasks. The clusters are organized in a structured form and accessible for reuse in the domain specific engineering systems of the multidimensional engineering system. The clusters allow for concurrent usage of the engineering data by a multitude of engineers by facilitating an engineer acquiring temporary ownership over a cluster while the engineer modifies the engineering data of the cluster and requiring that modifications to the engineering data follow the rules of the domain specific engineering application for engineering data.

Clustering engineering data supports a broad range of engineering tasks or responsibilities. Engineering data is structured in different views according to the needs of each of the engineering disciplines. An example of an engineering data structure in a multidisciplinary engineering system is an IEC 81346 compliant multidisciplinary engineering system. Engineering data clusters provide a way of grouping and structuring engineering data for specific engineering tasks. The creation of a data cluster is initiated by an engineer, who has an engineering task, problem or goal that can span multiple engineering disciplines. The engineering task may also be focused in a single engineering discipline.

In an implementation, a safety area is provided in a dedicated space of a plant production line. The safety area contains certain equipment that is deemed a hazard to humans during operation. For example, the equipment for the safety area includes a welding robot, a fixture for part fixation, in feed conveyor and a fence with a gate. The welding robot, when in action, can potentially harm the workers operating the production line. To prevent injuries, the equipment in the safety area (i.e., the welding robot, the fixture and the feed conveyor) should only be operated when the gate of the fence is closed and a panel button outside the fence is depressed. This configuration is designed to ensure the workers are outside of the fence and away from danger (i.e., the worker can only depress the button from outside the fence). A data cluster for the safety area is created containing the mechanical data for the equipment, the automation data for the equipment (i.e., PLC hardware and software) and the electrical data for the equipment (i.e., wiring, power supply, etc.). Engineering data for other engineering disciplines may also be included in the cluster. Clustering the engineering data for the safety area across engineering disciplines allows engineers to create cross-discipline workflows and model the safety area in the multidisciplinary engineering system.

In another implementation, PLC control systems are engineered based on a mechanically oriented functional breakdowns of the production line. For example, a data cluster is configured grouping engineering data for a specific PLC, such as the mechanical data for the conveyor(s) controlled by the PLC, the automation engineering data for the PLC, such as PLC software elements, and other engineering data for equipment specific to the PLC, such as light barrier sensors, drives and other equipment. The cluster is assigned to a specific PLC control system in the multidisciplinary engineering system, and the multidisciplinary engineering system can assign the sensors and other equipment input/output channels for the PLC in a bulk operation. Further, the software elements associated to the equipment can also be assigned to the controlling PLC with this operation.

Automation equipment from different engineered tasks often overlap, for example, when material is transferred from one conveyor to another to facilitate further processing. In this instance, equipment is controlled by various PLCs, with each PLC controlling one or more conveyors and other equipment. Engineering data for the various PLCs, conveyors and other equipment is reused by creating a data cluster for a PLC control system including the various PLCs, conveyors and other equipment to facilitate bus assignment and communication between the various equipment. For example, the PLCs, conveyors and other equipment in the PLC control system is added to the cluster for assignment to various bus controllers. The cluster reuses the engineering data to configure the bus assignment, such as by calculating start addresses for the equipment associated with the cluster and the address space of remote input/output channels. For example, the number of objects in a cluster are to be assigned to a bus, and engineering data from the objects is reused. In this example, each object has a bus specific interface, which allows parameters to be configured for the object to participate in the bus. In an example, one object is a bus master and the other objects are bus slaves. An example of data and parameters that may be reused are the bus address, timing behavior or gateway information. An existing engineering cluster is used to determine the bus participants from the objects in the cluster, with the system investigating all cluster objects for an existing and suitable bus interface. Each object has an interface that may be assigned to the bus. For example, the industrial buses can use Multi-Point Interface (MPI), Process Field Bus (Profibus), Profinet or Actuator Sensor Interface (AS-I), and the type of bus dictates the type of data that is reused during bus assignment.

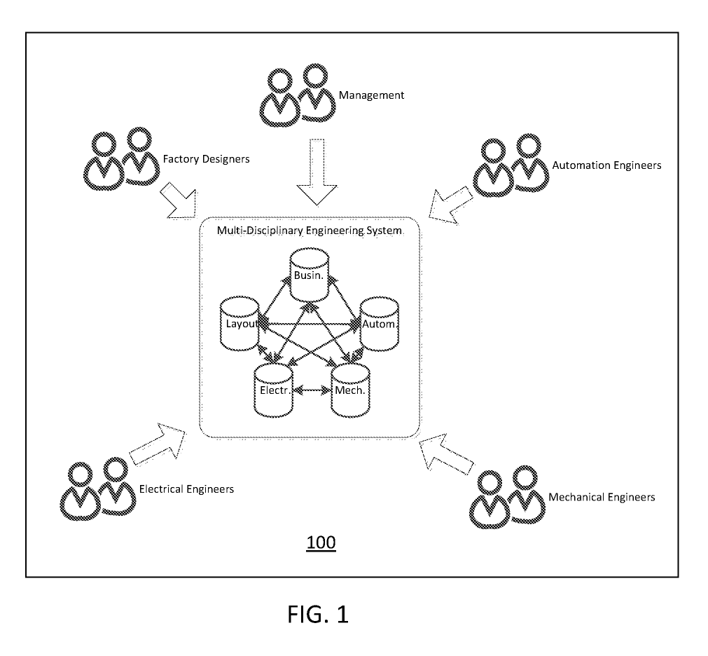

FIG. 1 illustrates an example of a multidisciplinary engineering system. The multidisciplinary engineering 100 includes a server and workstations. The server and/or workstations in the multidisciplinary engineering system 100 include engineering applications for various engineering disciplines. The engineering applications are directed to layout design, electrical design, mechanical design, automation design, and business functions. The engineering applications correspond to engineering disciplines, such as factory design, electrical engineering, mechanical engineering, automation engineering, and project management. Engineered devices and other objects are represented in the engineering applications in the multidisciplinary system, such as a conveyor on a factory assembly line. Each engineering application presents data differently, in a manner suited for the specific engineering discipline. Additional, different or fewer engineering applications and engineering disciplines may be provided. Alternatively, at least one of the engineering applications is directed to two or more engineering disciplines within a single application. Various engineers, designers, technicians, managers and other users access the engineering applications to complete tasks on the project. For example, in the context of an automobile factory, various engineers, designers and project managers plan a new production line for a car door assembly.

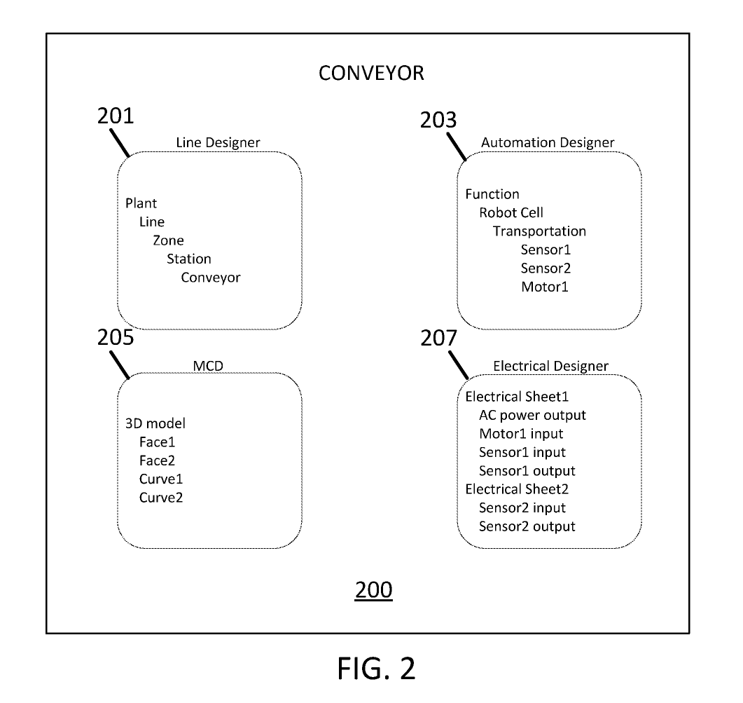

FIG. 2 illustrates an example of engineered data in a multidisciplinary system. In this example, a new production line includes the conveyor. Each engineering application 201, 203, 205 and 207 has a role with respect to the conveyor, and will have a different representation of data associated with the conveyor that is specific to the engineering application. Referring to FIG. 2, factory designers utilize a layout design application, such as line designer application 201, to plan the layout of the new production line, including the conveyor. The line designer application 201 displays information about the new production line, including the plant, line, zone and station where the conveyor will be placed. Automation engineers utilize the automation designer application 203 to plan the conveyor automation. Automation designer application 203 displays the function and robot cell of the conveyor, and the components of the conveyor that will be automated, including sensor1, sensor2 and motor1. Mechanical engineers utilize a mechanical design application, such as MCD 205, to plan the mechanical aspects of the conveyor. MCD 205 includes information about a three-dimensional (3D) model of the conveyor, including face1, face2, curve1 and curve2. Electrical engineers utilize the electrical designer application 207 to plan the electrical inputs and outputs for the conveyor. Electrical designer application 207 displays electrical information that will be provided to technicians installing the conveyor. Electrical sheet 1 includes an AC power output, motor1 input, sensor1 input and sensor1 output. Electrical sheet 2 includes a sensor2 input and sensor2 output. Additional and different roles and/or information may be provided.

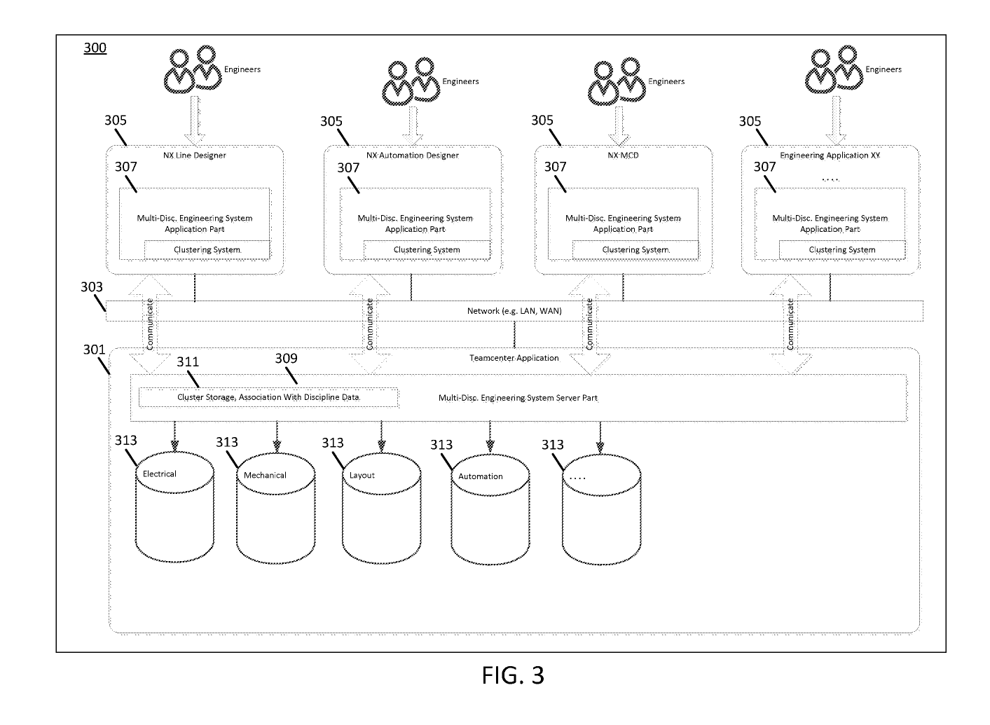

FIG. 3 illustrates an example implementation of a multidisciplinary system. In one embodiment, the multidisciplinary system is the Siemens Engineering Environment utilizing Siemens engineering tools and applications. Additional implementations may be provided in the same or other engineering systems.

The multidisciplinary system 300 includes a server 301, a network 303 and workstations 305. Additional, different, or fewer components may be provided. For example, more or fewer workstations 305 are used. As another example, additional networks and/or servers are used. In yet another example, a separate database managed or accessed by the server 301 or the workstations 305 is provided. Alternatively, the server 301 and the workstations 305 are directly connected, or implemented on a single computing device. Additionally, the server 301 can be a single physical server, a system of servers, a virtual server, as used in cloud computing and virtualization scenarios, or a system of virtual servers.

The server 301 includes a Teamcenter application 309 with cluster storage and cluster associations with engineering discipline specific engineering data (collectively, 311) and databases 313. The Teamcenter application 309 allows a user to add, delete or modify clusters of engineering data stored on server 301. The Teamcenter application 309 stores clusters of engineering data in the databases 313. Additional, different, or fewer components may be provided. For example, the Teamcenter application 309 may be uploaded to, and executed by, a processor in server 301. Likewise, processing strategies may include multiprocessing, multitasking, parallel processing and the like. The server 301 is implemented on a computer platform having hardware such as one or more central processing units (CPU), a random access memory (RAM), and input/output (I/O) interface(s). The computer platform also includes an operating system and microinstruction code. The various processes and functions described herein may be either part of the microinstruction code or part of the program (or combination thereof) which is executed via the operating system. Alternatively, the server 301 includes one or more processors in a network.

The Teamcenter application 309 also serves as a meta-model based repository system and data platform for the engineering applications 307 by storing data received from the engineering applications 307 in the databases 313. The data received from the engineering applications 307 includes project specific data, such as object and parameter names, parameter values, device specifications, and/or other information. The Teamcenter application 309 operates as a multidisciplinary system server that communicates information to/from the engineering applications 307 over the network 303. The databases 313 are referenced by the connectivity model when generating PLC code. The Teamcenter application 309 also stores a library of application objects and the links between instantiated library objects.

The multidisciplinary system 300 includes workstations 305 with engineering applications 307 corresponding to various engineering disciplines and engineering roles. For example, NX Line Designer is a layout design application, such as the line designer application 201, NX Automation Designer is an automation engineering application, such as automation designer application 203, NX MCD is a three-dimensional (3D) modeling application, such as MCD 205, and NX Electrical Designer is an electrical engineering application, such as electrical designer application 207. Different or fewer engineering applications, engineering disciplines and engineering roles may be provided. A different engineering application is referred to as Engineering Application XY, corresponding to any other engineering discipline XY. Various engineers, designers, technicians, managers and other users access the engineering applications, such as line design engineers, automation engineers, MCD engineers and XY engineers. Workstations 305 with engineering applications 307 form a multidisciplinary engineering system, such as multidisciplinary engineering system 100.

The workstations 305 include engineering applications 307. The engineering applications 307 include a clustering system that is configured to group engineering data into clusters that are stored on the server 301. Alternatively, the clustering system may be hosted on the server 301, with the server 301 is configured to group engineering data into clusters that are stored on the server 301 or on workstations 305.

The multidisciplinary system 300 includes a network 203. The network 203 is a wired or wireless network, or a combination thereof. The network 203 is configured as a local area network (LAN), wide area network (WAN), intranet, internet or other now known or later developed network configurations. Any network or combination of networks for communicating between the role-specific applications and the server for hosting the templates, data, or other information of the engineering system may be used.

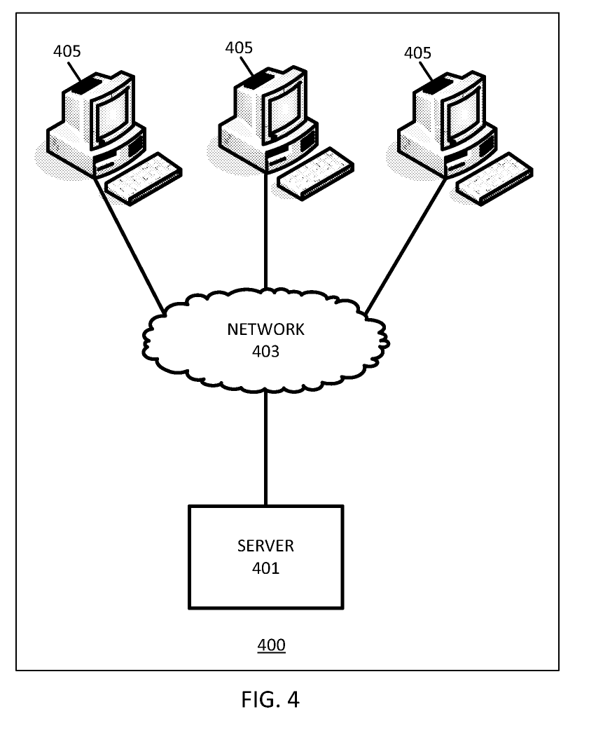

FIG. 4 illustrates an embodiment of a system for clustering engineering data in a multidisciplinary engineering system. The multidisciplinary system 400 includes a server 401, a network 403 and workstations 405. Additional, different, or fewer components may be provided. For example, additional or fewer workstations 405 are used. As another example, additional networks and/or servers are used. In yet another example, separate databases are managed and/or accessed by the server 401 and workstations 405. Server 401 is a server computer platform having hardware such as one or more central processing units (CPU), a system memory, a random access memory (RAM) and input/output (I/O) interface(s). The server 401 is implemented on one or more server computers connected to network 403. Additional, different or fewer server components may be provided.

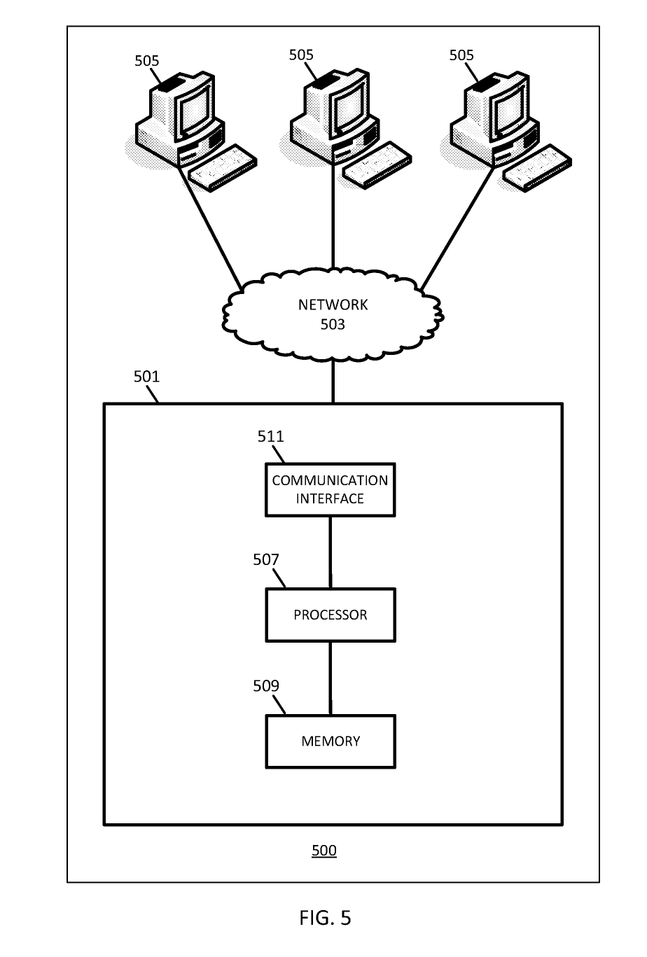

The server 401 is configured to store a cluster of multidisciplinary engineering data representing a portion of an engineering model in the multidisciplinary engineering system. The workstations 405 access, display and modify the cluster of multidisciplinary engineering data. The server 401 may transmit the cluster of multidisciplinary engineering data to one or more workstations 405. Alternatively, as illustrated in FIG. 5, the server 501 accesses, displays and modifies the cluster of multidisciplinary engineering data. The cluster of multidisciplinary engineering data may be stored on one or more workstations 505, the server 501 or a combination thereof. In yet another alternative, the server 401 is implemented by one or more workstations 405 so that one or more of the engineering applications host the server functions.

The server 401 is configured to store a cluster of multidisciplinary engineering data representing a portion of an engineering model in the multidisciplinary engineering system. The cluster for a system, sub-system, portion of a facility, an area, a device, a group of devices, or other grouping used in engineering. For example, the cluster is stored for a safety area in a dedicated space of a plant production line. The server 401 may store more than one cluster, such as multiple safety areas in different locations in the plant production line. Alternatively, a cluster of multidisciplinary engineering data may be stored for a portion of an automation system for a plant production line. The cluster represents a portion of the engineering model in the multidisciplinary engineering for the plant production line and includes engineering data for the subsystem in the engineering model.

The stored cluster of multidisciplinary engineering data has general properties, such as a name and description that identifies the cluster and describes the engineering context and purpose of the cluster. Other properties and metadata may be provided. The cluster includes engineering application data associated with the cluster. The engineering data associated with the cluster is represented in different engineering applications with different roles in the multidisciplinary engineering system. For example, referring back to FIG. 2, engineering data in the multidisciplinary engineering system may include data regarding a conveyor on a new production line. This engineering data includes layout design data, automation design data, mechanical design data, and electrical design data. The engineering data is associated with engineering discipline specific applications and is referred to as engineering application objects. The engineering data may be associated with one or more clusters stored on server 401. The cluster also stores information about which engineering applications have engineering data associated with the cluster. The engineering data associated with the cluster can be filtered based on engineering application, discipline of interest or another category of engineering data.

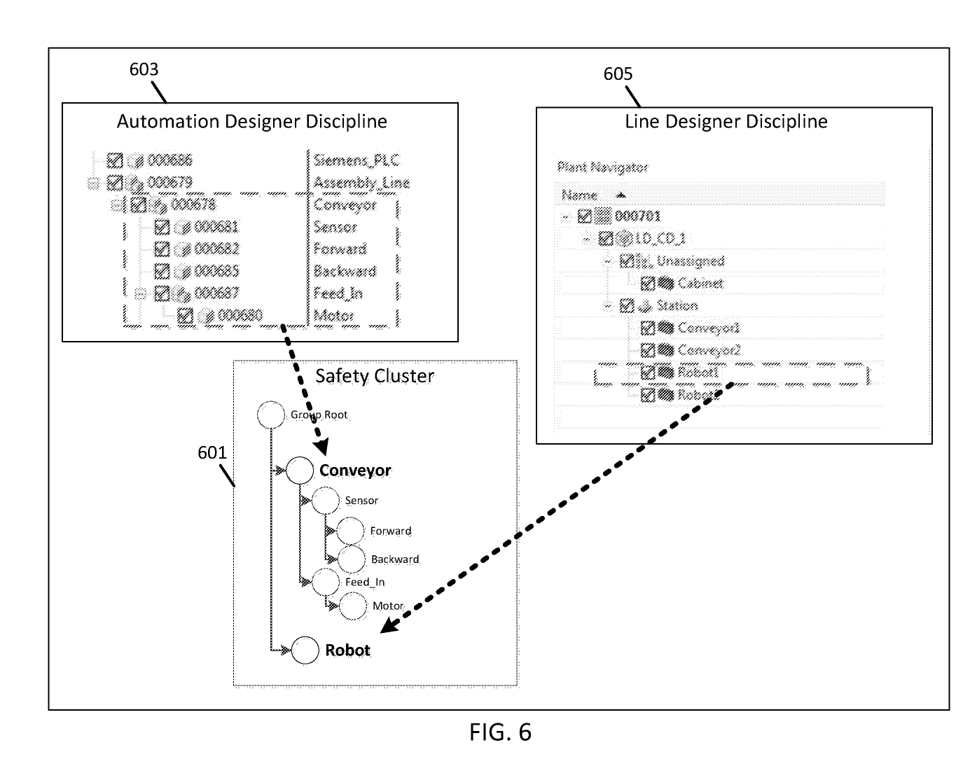

For example, FIG. 6 illustrates an example of adding engineering application data to a cluster of engineering application data. Once a cluster is defined, engineering data is added or removed from the cluster. Engineering data can be added from any of the engineering discipline specific engineering applications. For example, a safety cluster 601 is defined and stored on the server 401. Engineering data is grouped in the cluster 601 from the automation designer discipline 603 (i.e., a conveyor, sensors, such as a forward direction sensor and a backward direction sensor, a feed-in and a motor) and the line designer discipline 605 (i.e., a robot). Engineering data may be added to multiple clusters. For example, in an automation project, a sensor is grouped with other sensors and engineering data in one cluster for the purpose of input/output assignment and the same sensor is also grouped with a robot, a conveyor and a fence in a second cluster to for the purpose of modeling a dedicated safety area. In some embodiments, engineering data can only be added once to any cluster.

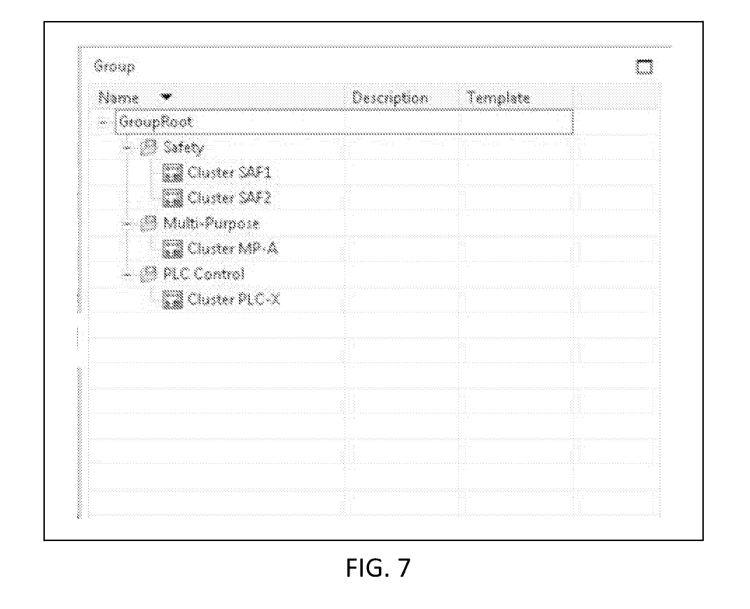

The engineering data in the clusters are grouped in a data structure. For example, FIG. 7 illustrates an example of clusters organized in a hierarchical structure. As illustrated in FIG. 7, the safety clusters SAF1, SAF2, the multi-purpose cluster MP-A and the PLC control cluster PLC-X are organized in a structural way. The structure of the clusters is visualized in a tree form with the root node GroupRoot being the cluster root holding the clusters. Engineering data and folder structures organize the clusters according to domain needs, such as safety, multi-purpose and PLC control. Within each cluster, a data structure is also employed. For example, referring to FIG. 6, the safety cluster 601 includes four levels of data. First, a root is provided (i.e., Group Root). Next, a Conveyor group and a Robot group are underneath the root. Next, under the Conveyor group is a Sensor group and a Feed_In group. The Sensor group has a forward direction sensor and a backward direction sensor, and the Feed-In group has a Motor. Other data structures may be provided. For example, engineering data in a cluster may be organized with an internal structure, where the internal structure depends on the type of data that is contained in the cluster. Engineering data may be organized in a discipline specific manner, for example in an IEC 81346 aspect compliant structure or in a mechanical assembly tree, and a cluster can take advantage of the discipline specific organizational structure. For example, a cluster considers the topmost structure objects as engineering data directly grouped in the cluster, whereas dependent structure objects are treated as engineering data indirectly grouped in the cluster.

Referring again to FIG. 4, workstations 405 are in communication with the server 401 over a network 403. The workstations 405 are configured to execute one or more engineering applications to access, display and modify the cluster stored on server 401. The cluster is visible and usable by all engineers with access to the multidisciplinary engineering system. The multidisciplinary engineering system provides for restricting access to the cluster if desired. For example, access may be restricted based on user specific credentials and/or a group domain. The clustered engineering data is accessed in a holistic way. Alternatively, the clustered engineering data may be accessed in a manner specific to one engineering discipline, or in a select number of engineering disciplines. The cluster can be accessed in the different engineering applications by filtering the plurality of application data by one of the different engineering disciplines. For example, referring back to FIG. 6, the application data in the safety cluster 601 is filtered to show the application data associated with the automation designer discipline 603 only (i.e., the conveyor, the sensors, the feed-in and the motor). Alternatively, the application data in the safety cluster 601 is filtered to show the application data associated with the line designer discipline 605 only (i.e., the robot).

An engineer uses the clustered data from only one or more select disciplines in an engineering task, and can choose to access and utilize only the engineering data that affects the engineering task or a discipline specific data construct. The cluster is displayed to the user in a workstation 405, for example, according to the data structure of the cluster. For example, engineering data is displayed in a hierarchical tree structure, with a root node and one or more levels of data under the root as shown in FIGS. 6 and 7. The workstations 405 are configured to display the plurality of engineering data to a plurality of users in at least two of the different engineering applications, or alternatively, only the engineering data associated each engineering application is displayed in the associated application. Alternatively, an engineer can select a cluster for display, then select specific engineering data or engineering data for a specific engineering discipline for display. The engineer can choose what aspects of the engineering data are displayed, such as metadata, connections between data entries, the status of the data (i.e., whether the configuration of an engineering aspect has been completed) and revision history. The displayed cluster can also indicate whether another engineer has temporary ownership over the cluster.

The workstations 405 are configured to modify the engineering application data associated with the accessed cluster. An engineering application modifies the engineering data in any manner as required to accomplish an engineering task. An engineering application acquires temporary ownership over the engineering data being modified, preventing conflicting changes from being made. For example, in a multidisciplinary engineering system, clusters are accessed in parallel by multiple engineers. Access includes information about the cluster as well as about the grouped and associated engineering data. Modifications to the engineering data follow rules of the domain specific engineering application that the data belongs to. To modify the engineering data grouped in the cluster, an engineer acquires temporary ownership over the cluster, prohibiting multiple engineers from creating conflicting modifications. Alternatively, the engineer acquires temporary ownership over the engineering data to be modified only, allowing other users to modify different engineering data in the cluster. After the modification is finished, the engineer returns the ownership of the cluster to the multidisciplinary engineering system and the modification becomes available to all engineers accessing the cluster.

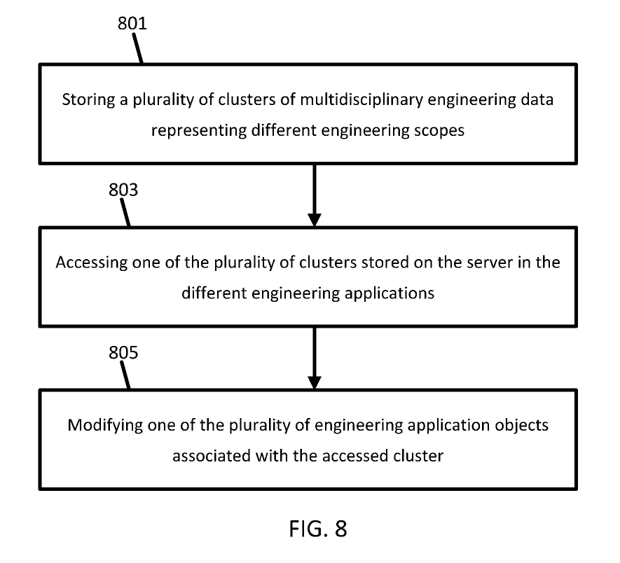

FIG. 8 is a flowchart diagram of an embodiment of a method for clustering engineering data in a multidisciplinary engineering system. The method is implemented by the system of FIG. 3, 4, 5 and/or a different system. A processor or group of networked processors perform the acts, such as pursuant to instructions, programming or circuit design. Additional, different or fewer acts may be provided. The method is provided in the order shown. Other orders may be provided and acts may be repeated.

At act 801, a cluster of multidisciplinary engineering data is stored on a server, workstation, computer, engineering application, or other location. More than one cluster may be stored. The cluster includes a unique identifier and engineering application data associated with the cluster. The unique identifier identifies the engineering context of the cluster. The context of the cluster identifies an engineering task or responsibility using the application objects associated with the cluster, such as a safety system or an automation system. Some of the engineering application data may be associated with more than one cluster.

At 803, the cluster of multidisciplinary engineering data is accessed in an engineering application executed by on a server, workstation, computer, engineering application, or other location. More than one cluster may be accessed. The engineering data associated with the cluster can be filtered based on the engineering discipline of the engineering data. The cluster of engineering data is displayed to a user in one or more of the engineering discipline specific applications. Alternatively, only engineering data from the cluster that is associated with the engineering application is displayed.

At act 805, the cluster of multidisciplinary engineering data is modified by the engineering application executed by on a server, workstation, computer, engineering application, or other location. In one embodiment, modifying the cluster may require acquiring temporary ownership over the cluster or the engineering data being modified.

Clustering engineering data in a multidisciplinary engineering system may result in reduced engineering efforts because clustering engineering data may make engineering discipline workflow synchronization and data organization more efficient and may reduce the overall effort for the engineers in a complex engineering project, such as planning an automotive factory. Clustering engineering data in a multidisciplinary engineering system may result in shorter time to market because clustering data across engineering disciplines may increase the efficiency of the engineering processes by allowing for bulk operations across disciplines. Clustering engineering data in a multidisciplinary engineering system may enhance the quality of the output of the overall engineering process by avoiding human introduced data synchronization errors in interdisciplinary workflows. Greater integration with existing engineering applications may be provided because it is possible to adapt this system and method to existing and future multidisciplinary engineering systems. The aforementioned advantages may result in investment savings and reduced risks, especially for large engineering companies that use set processes and standards. Some example industries that may benefit from the disclosed embodiments are automobile, logistics and machine building. However other industries may also benefit from the disclosed embodiments. For example, engineering workflows in the automation engineering discipline, among other, use clustering of engineering data in a multidisciplinary engineering system. The following examples and embodiments are exemplary of automation and mechanical disciplines, but many more example implementations can be used in all of the various engineering disciplines.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

We claim:

1. A method for clustering engineering data in a multidisciplinary engineering system, the method comprising:
storing 801, by a server 301, a cluster 601 of multidisciplinary engineering data representing an engineering context, the cluster 601 comprising:
a unique identifier associated with the cluster 601;
engineering application objects associated with the cluster 601, wherein different ones of the engineering objects are represented in different engineering applications 307 for different engineering disciplines with different roles in the multidisciplinary engineering system;
accessing 803, with a computer 305 over a network 303, the cluster 601 in one of the different engineering applications 307; and
modifying 805, with computer 305, one of the plurality of engineering application objects associated with the accessed cluster 601.

2. The method of claim 1 wherein accessing 803 the cluster 601 comprises filtering the plurality of application objects to access application objects represented in different ones of the different engineering applications 307.

3. The method of claim 1 wherein the plurality of engineering application objects are associated with the cluster 601 in a tree data structure comprising a root node representing the cluster 601 and a plurality of nodes under the root node representing the plurality of engineering application objects associated with the cluster 601.

4. The method of claim 1 wherein the unique identifier associated with the cluster 601 identifies the engineering context of the cluster 601.

5. The method of claim 5 wherein the context of the cluster 601 comprises an engineering task or responsibility for the plurality of application objects associated with the cluster 601.

6. The method of claim 5 wherein the context of the cluster 601 comprises application objects associated with a safety system or an automation system.

7. The method of claim 1 wherein accessing 803 the cluster 601 comprises accessing the plurality of engineering objects by a plurality of engineers in at least one of the different engineering applications 307.

8. The method of claim 7 wherein modifying 805 one of the engineering application objects associated with the accessed cluster 601 comprises acquiring temporary ownership over the engineering application object being modified.

9. The method of claim 7 wherein modifying 805 one of the engineering application objects associated with the accessed cluster 601 comprises acquiring temporary ownership over the plurality of engineering application objects associated with the cluster 601.

10. A multidisciplinary engineering system comprising:
a server 301 configured to store a cluster 601 of multidisciplinary engineering data representing a portion of an engineering model in the multidisciplinary engineering system, the cluster 601 comprising a plurality of engineering application data associated with the cluster 601, wherein the plurality of engineering data is represented in different engineering applications 307 for different engineering disciplines with different roles in the multidisciplinary engineering system; and
a plurality of workstations 305 in communication with the server 301 over a network 303, the plurality of workstations 305 configured to execute one of the different engineering applications 307 to access the cluster 601 and to modify the plurality of engineering application data associated with the accessed cluster 601.

11. The system of claim 10 wherein the plurality of workstations 305 access the cluster 601 in the different engineering applications 307 by filtering the plurality of application data by one of the different engineering disciplines.

12. The system of claim 10 wherein the plurality of workstations 305 are configured to display the plurality of engineering data to a plurality of users in at least two of the different engineering applications 307.

13. The system of claim 10 wherein the plurality of workstations 305 are configured to modify the engineering application data associated with the accessed cluster 601 by acquiring temporary ownership over the engineering application data being modified.

14. The system of claim 10 wherein the plurality of workstations 305 are configured to modify the engineering application data associated with the accessed cluster 601 by acquiring temporary ownership over the plurality of engineering application data associated with the cluster 601.

15. The system of claim 10 wherein the portion of the engineering model in the multidisciplinary engineering comprises engineering data representing a subsystem in the engineering model.

16. The system of claim 15 wherein the subsystem comprises application data associated with a safety system or an automation system.

17. A method for clustering engineering data in a multidisciplinary engineering system, the method comprising:
Storing 801, with a server 301, a plurality of clusters 601 of multidisciplinary engineering data representing different engineering scopes, the clusters 601 comprising:
one of a plurality of unique identifiers associated with each of the plurality of clusters 601;
a plurality of engineering application data associated with each of the plurality of clusters 601, wherein the plurality of engineering data represents an engineering model across different engineering applications 307 for different engineering disciplines with different roles in the multidisciplinary engineering system;
accessing 803, with a computer 305 over a network 303, one of the plurality of clusters 601 stored on the server 301 in the different engineering applications 307; and
modifying 805 the engineering application data associated with the accessed cluster 601 in the engineering application 307.

18. The method of claim 17 wherein accessing 803 the plurality of plurality of clusters 601 comprises displaying the plurality of clusters 601 and the plurality of engineering data in a tree structure, the tree structure comprising:
a root node;
a plurality of nodes associated with the plurality of clusters 601 under the root node; and
a plurality of nodes associated with the plurality of application data under the a plurality of nodes associated with the plurality of clusters 601.

19. The method of claim 17 wherein accessing 803 the plurality of clusters 601 comprises displaying, in each the different engineering applications 307, only the engineering data associated the engineering application 307.

20. The method of claim 17 wherein some of the plurality of engineering application data is associated with two of the plurality of clusters 601.
